(19) United States
(12) Patent Application Publication
(10) Pub. No.: US 2013/0166042 A1
(43) Pub. Date: Jun. 27, 2013

(54) MEDIA CONTENT-BASED CONTROL OF AMBIENT ENVIRONMENT

(71) Applicant: HEWLETT-PACKARD DEVELOPMENT COMPAN, Houston, TX (US)

(72) Inventors: Vimal SHARMA, Bangalore (IN); Praphul CHANDRA, Bangalore (IN)

(73) Assignee: HEWLETT-PACKARD DEVELOPMENT COMPANY, L.P., Houston, TX (US)

(21) Appl. No.: 13/627,662

(22) Filed: Sep. 26, 2012

(30) Foreign Application Priority Data
Dec. 26, 2011 (IN) 4578/CHE/2011

(51) Int. Cl. G05B 13/02

(52) U.S. Cl. 700/28

(57) ABSTRACT

Provided is a method of controlling an ambient environment based on content of a media. The content of a media is analyzed to identify a prevalent human emotion. A pre-defined ambient environment parameter corresponding to the identified human emotion is recognized. Control signals are generated based on the pre-defined ambient environment parameter and sent to an ambient environment unit for creating an ambient environment corresponding to the pre-defined ambient environment parameter.

### CLAIM FOR PRIORITY

The present application claims priority under 35 U.S.C 119 (a)-(d) to Indian Patent application number 4578/CHE/2011, filed on Dec. 26, 2011, which is incorporated by reference herein in its entirety.

### BACKGROUND

Media consumption has undergone a sea change over the past few decades. Gone are the days when radio and television used to be the primary source of entertainment for people. With the arrival of the internet and development of portable media consumption devices, such as media players, mobile phones, laptops, tablets, etc. a user has an option of enjoying media at a time and place of his choice. In addition, there's no dearth of media which is available to a consumer. However, in spite of easy availability, portability and a plethora of content options, barring a few exceptions, a user has very limited control over the environment under which he or she consumes media. There's typically no synchronization between the media consumed and a user's ambient environment.

### BRIEF DESCRIPTION OF THE DRAWINGS

For a better understanding of the solution, embodiments will now be described, purely by way of example, with reference to the accompanying drawings, in which:

FIG. 1 illustrates a representative ambient environment, according to an embodiment.

FIG. 2 illustrates a block diagram of system for controlling an ambient environment based on content of a media, according to an embodiment.

FIG. 3 illustrates a mapping between human emotions and corresponding ambient environment, according to an embodiment.

FIG. 4 illustrates a flow chart of a method of controlling an ambient environment based on content of a media, according to an embodiment.

### DETAILED DESCRIPTION OF THE INVENTION

As mentioned above, except for a few situations, there's typically a world of difference between the content which is being consumed by a user and his ambient environment. For example, a user might be listening to soft country music, but the ambient area (let's say, a hall) may be brightly lit through multiple light sources. Needless to say, this is not a perfect situation from a user's perspective who would ideally prefer a more relaxed ambience (for instance where there are soft, subdued lights, typically considered idyllic for country music) to enjoy his media. Of course, in some cases, a user could always control his ambient environment to synchronize, at least to some extent, the content being consumed with the environment. For example, this may be possible at user's home, during a wedding function, at a party, and the like environments.

An increasingly large number of people are opting for custom installations, such as mood lighting and surround sound systems in their homes (or places where they have control) so that they could have some degree of influence over their ambient environment. Such custom installations allow these users to exercise a certain degree of synchronization between the media that they wish to consume and the ambient environment. For instance, if a user is watching a horror movie on his home theatre, he may like to dim the ambient light sources to a low, dim level, in order to experience the actual thrill and excitement that is typically obtained when one watches movies of such genre in aforementioned environment.

One limitation of the above approach is that a user is manually required to modify his ambient environment to align with the media that he or she wants to consume. Needless to say, this is not convenient from a user's perspective.

Embodiments of the present solution provide a method and system for automatically changing the ambient environment based on the content being consumed by a user.

For the sake of clarity, the term “media” as used in this document includes electronic media, such as audio, video, images, multimedia, text and other forms of electronic data, symbols and representations.

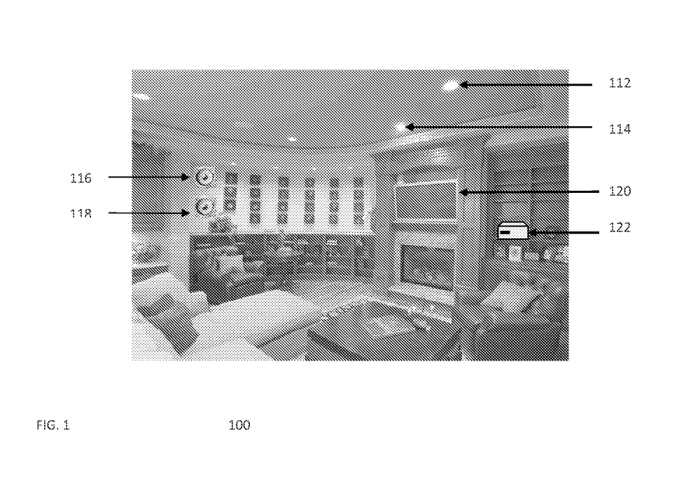

FIG. 1 illustrates a representative ambient environment 100 for implementing the proposed solution, according to an embodiment.

In the present example, the representative ambient environment is a user's home. However, this is only for the purpose of illustration, and the proposed solution may be implemented in other environments, such as, but not limited to, an office, a movie hall, an auditorium, a discotheque, a hospital, a library, a hotel, and so on and so forth.

The representative ambient environment 100 includes artificial lightning units (112, 114), audio units (116, 118), a media device 120 (such as a television set) and a control system 122. It may be noted that the proposed solution is not limited to a particular number (or type) of lightning units, audio units and media players (as illustrated in FIG. 1), and any number of these resources or units may be employed by a user in an environment.

Artificial lightning units (112, 114) may include units, such as, but not limited to, conventional incandescent light bulbs, flashlights, Halogen lamps, LED lamps, fluorescent lamps, Neon lamps, Xenon lamps, and the like. Artificial lightning units (112, 114) are capable of emitting lights in various colors, shades and hues based on an input data and/or signal, which may be provided through wired or wireless means.

Audio units (116, 118) may include devices, such as, but not limited to, a standalone speaker, an audio-visual system, a home theatre system, a cassette player, a radio player, a disc (such as CD, DVD, and the like) player, and the like. Audio units are capable of rendering sound in various tones and pitch based on an input data and/or signal, which may be provided through wired or wireless means.

Media devices 120 may include devices, such as, but not limited to, a television set, a home theatre system, a cassette player, a compact disc (CD) player, a DVD player, a radio, a set-top box, a blue-ray player, a digital video recorder (DVR), and the like. Media device 120 includes both media playing and media recording devices.

In the present example, artificial lighting units (112, 114) and audio units (116, 118) form the components that may be used to modify the representative ambient environment for the purpose of this disclosure.

The artificial lighting units (112, 114), audio units (116, 118) and media device 120 may be connected to each other through wired (for example, co-axial cable) or wireless (for example, infrared, Bluetooth, Wi-Fi and/or ZigBee) means. They can communicate data and/or signals with each other.

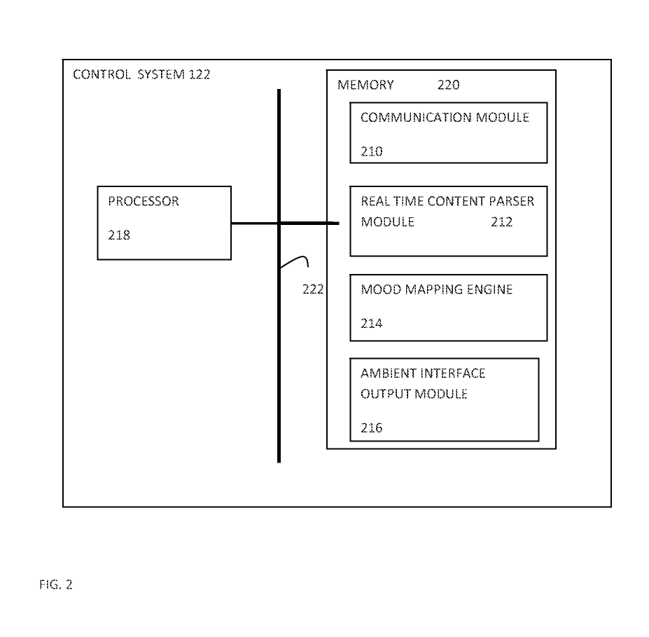

Control system 122 is used to control artificial lightning units (112, 114) and audio units (116, 118), which in turn modify the ambient environment. The control system 122 (described in detail below and illustrated in FIG. 2) may communicate with lightning units (112, 114) and audio units (116, 118) through wired or wireless communication means to exchange data and/or signals.

FIG. 2 illustrates a block diagram of system for controlling an ambient environment based on the content of a media, according to an embodiment.

Control system 122 may be a computing device, such as, but not limited to, a desktop computer, a notebook computer, a server computer, a personal digital assistant (PDA), a mobile device, a television (TV), a docking device, etc. It may be connected to a broadcast network and/or a computer network, such as, an intranet or the internet (World Wide Web). Additionally, it may be a standalone device or integrated with another device, such as a media playing device (for example, TV, music player, disc player, computer system, etc.).

In an example, the control system 122 is an interface device between a display device and a media device (media playing and/or receiving device). The display device may be a liquid crystal display (LCD), a light-emitting diode (LED) display, a plasma display panel, a television, a computer monitor, and the like. A media receiving device may be a broadcast receiver, such as a satellite set-top box, a digital cable set-top box, an analogue broadcast receiver, and the like. A media playing device may include a compact disc (CD) player, a cassette player, a digital versatile disc (DVD) player, a MP3 player, a music system, box, a Blu-ray player, a combination of any of the aforesaid units, and the like.

The control system 122 may communicate with a display device and a media receiving (or playing) device through wired (for example, co-axial cable) or wireless (for example, infrared, Bluetooth, Wi-Fi and/or ZigBee) communication means to exchange data and/or signals.

The control system 122 may also communicate with artificial lightning units (such as 112, 114 of FIG. 1) and audio units (such as 116, 118 of FIG. 1) through wired (for example, co-axial cable) or wireless (for example, infrared, Bluetooth, Wi-Fi and/or ZigBee) communication means to exchange data and/or signals.

Control system 122 includes a communication module 210, a real time content parser module 212, a mood mapping engine 214 and an ambient interface output module 216.

The communication module 210 is used for receiving and transmitting data and/or signals through wired or wireless communication means. In an example, the communication module 210 may be an infrared (IR) module for receiving (receiver) and transmitting (transmitter) an IR command. In other examples, however, the communication module may be a Bluetooth module for receiving (receiver) and transmitting (transmitter) a Bluetooth command, a Wi-Fi module for receiving (receiver) and transmitting (transmitter) a WiFi command or a ZigBee module for receiving (receiver) and transmitting (transmitter) a ZigBee command. In other words, the control system 122 can support multiple wireless communication means and protocols.

In an example, the communication module 210 receives a media from a media device (such as media device 120 of FIG. 1) and transfers it to a real time content parser module 212 of the control system 122.

Real time content parser module 212 is responsible for analyzing a media's content. It interprets the type of content which is being played on a media device. For example, if a video is being played on a media device (such as 120 of FIG. 1) and displayed through a display device, the real time content parser module 124 analyzes the content of the video to identify the prevalent human mood or emotion. For instance, it tries to understand whether the content is “comic”, “mystery”, “action”, “romantic”, “musical”, “animation” and so on and so forth.

Real time content parser module 212 extracts the semantics and sentics of a media's content (media metadata), and translates it into a general human mood or emotion which is interpretable by the control system. In an instance, the media is transcribed to text, and artificial intelligence and semantic web techniques are used to recognize, interpret and process sentiments in the transcribed text. In one example, a natural language processing module (NLP) module may be used to parse the textual metadata associated with the media to output lemmatized text. The NLP module recognizes the affective valence (sentics/semantics) indicators usually present in a text. Some of these indicators may include exclamation words, emoticons, degree adverbs, etc. The lemmatized text is parsed by a semantic parser to extract concepts (from text) using a lexicon based on n-grams. In an instance, the ConceptNet lexicon is used for concept extraction. The extracted concepts may be further processed to obtain sentic information. This may be done by projecting the retrieved concepts into a multi-dimensional vector space built by applying a bending technique. A linguistic resource, such as WordNet-Affect, is the then used along with the ConceptNet lexicon to form a large matrix. In this matrix, the rows may be concepts and columns may be either common-sense assertion relations or affective features. Subsequently, a truncated singular value decomposition (SVD) is applied to the matrix along with the hour-glass model of emotions to infer the affective valence of the retrieved concepts.

A few non-limiting examples of media metadata which may be extracted from a media (such as audio, video or images) are given below:

Action, Adventure, Animation, Biography, Comedy, Crime,

Documentary, Drama, Family, Fantasy, Game-Show, History, Horror, Musical, Mystery, News, Romance, Sport, Talk-show, Thriller, War, Western.

Once extracted, the media metadata is mapped to a human emotion (or mood) by a mood mapping engine 214. To illustrate, if the media metadata indicates that the media content relates to a humorous or funny situation, the mood mapping engine 214 maps the extracted metadata to a laughing or giggling human emotion. Since a metadata is representative of the content being played, the media content is identified as “Comic” or “Comedy”, and the like. To provide another illustration, if the media metadata is identified as “Drama” (may be because there's too much conversation taking place between the speakers with frequent changes in tone and pitch), the mood mapping engine 214 may map the extracted metadata to a quite or serious human emotion.

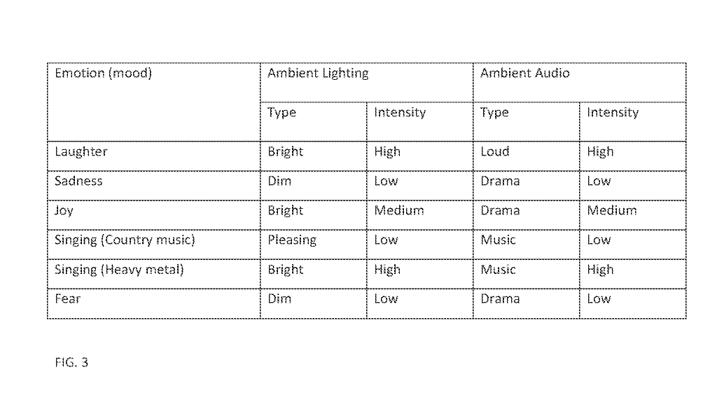

Ambient interface output module 216 obtains a mapped human emotion from the mood mapping engine 214 and identifies an ambient environment associated with it. The association between a human emotion and ambient environment may be pre-defined in the control system 122, which includes a repository 218 containing a mapping of human emotions (moods) and ambient environment. For instance, if the identified human emotion (in the media being played) is “laughter”, the corresponding ambient environment may include “bright lights” and/or cheerful “loud audio”. In another instance, if the mapped human emotion is “sadness”, the corresponding ambient environment may include “dim lights” and/or “low audio”. A representative repository indicating a mapping between human emotions (moods) and various ambient environments is illustrated in FIG. 3, according to an embodiment. The ambient environment includes two aspects: ambient lighting and ambient audio. Both these aspects may be further classified based on form (type) and level (intensity) of the medium. Also, each parameter (for example, Intensity) may take different values (for example, Intensity: high, medium, low, etc.). The illustrated mapping is just a representative non-limiting sample and various variations are possible, which would be within the scope of this disclosure.

In an example, a user can also specify the mapping between a human emotion (or mood) and an ambient environment. The user can also specify (or modify) the form (type) and level (intensity) of ambient lighting and audio.

Once an ambient environment associated with a human emotion (from the media being played) has been identified, the ambient interface output module 216 passes the relevant ambient light and audio related information to the communication module 210. The communication module 210, in turn, outputs this information in the form of signals and/or data (through wired or wireless means) to ambient artificial lightning units (112, 114) and audio units (116, 118). The ambient artificial lightning units (112, 114) and audio units (116, 118) interpret these signals and implement the mapped ambient lighting and audio parameters.

Control system 122 may include a processor 218, for executing machine readable instructions, and a memory (storage medium) 220, for storing machine readable instructions (such as, modules 210, 212, 214, 216). In an example, the control system 110 may also include a display. These components may be coupled together through a system bus 222.

Processor 218 is arranged to execute machine readable instructions. The machine readable instructions may be in the form of modules 210, 212, 214, 216 or an application for executing a number of processes. In an example, the processor executes machine readable instructions, stored in memory 220, to: analyze content of the media to identify a human emotion; recognize a pre-defined ambient environment parameter corresponding to the identified human emotion; generate control signals based on the pre-defined ambient environment parameter; and send the control signals to an ambient environment unit for creating an ambient environment corresponding to the pre-defined ambient environment parameter.

It is clarified that the term “module”, as used in this document, may mean to include a software component, a hardware component or a combination thereof. A module may include, by way of example, components, such as software components, processes, functions, attributes, procedures, drivers, firmware, data, databases, and data structures. The module may reside on a volatile or non-volatile storage medium and configured to interact with a processor of a computer system.

The memory 220 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 220 may include modules, such as, but not limited to, communication module 210, a real time content parser module 212, a mood mapping engine 214 and an ambient interface output module 216. The memory may also include a repository (database) containing a mapping between human emotions (moods) and various ambient environments (including their parameters). In an example, memory 220 includes machine readable instructions to: analyze content of the media to identify a human emotion; recognize a pre-defined ambient environment parameter corresponding to the identified human emotion; generate control signals based on the pre-defined ambient environment parameter; and send the control signals to an ambient environment unit for creating an ambient environment corresponding to the pre-defined ambient environment parameter.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including servers, connected together through suitable means.

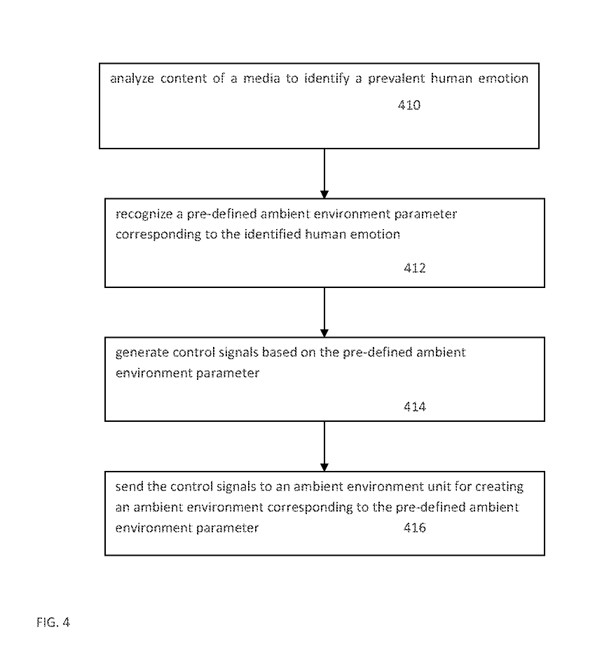

FIG. 4 illustrates a flow chart of a method of controlling an ambient environment based on content of a media, according to an embodiment.

The method may be implemented in a system which may be a computing device, such as, but not limited to, a desktop computer, a notebook computer, a server computer, a personal digital assistant (PDA), a mobile device, a television (TV), a docking device, and the like. In an example, the method may be implemented in a control system 122, as described earlier.

At block 410, the content of a playing media (such as, audio or video) is analyzed to identify a prevalent human mood or emotion. In an example, a communication module of a control system receives media (in an example, a currently playing media) from a media device. The obtained media is transferred to a real time content parser module of the control system for content analysis. The content analysis involves an evaluation of the semantics and sentics of the media (media metadata) to identify a general (or prevalent) human mood or emotion.

To provide an illustration, based on semantics and sentic analysis of a media, it may be analyzed that the extracted metadata corresponds to a laughing or giggling human emotion. In such case, the media content may be identified as “Comic” or “Comedy”, and the like.

At block 412, once the prevalent human emotion is identified for a media, the human emotion is mapped to a user-defined or pre-defined ambient environment setting (or parameters). In an example, the mapping is performed automatically by a mood mapping engine of the control system.

The ambient environment setting includes two aspects: ambient lighting setting and ambient audio setting. These settings may be pre-defined or user-defined. The settings for ambient lighting and ambient audio vary according to the mapped human emotion (or mood), and different settings may be defined for various emotions. To provide an illustration, for human emotion “laughter”, the ambient lighting settings may be “Bright” (type) and “High” (intensity), and the ambient audio settings may be “Loud” (type) and “High” (intensity). To provide an another illustration, for human emotion “fear”, the ambient lighting settings may be “Dim” (type) and “Low” (intensity), and the ambient audio settings may be “Drama” (type) and “Low” (intensity).

The pre-defined or user-defined ambient environment settings (ambient lighting and ambient audio) represent those conditions of the ambient environment which may be typically preferred by a user while he is consuming content of a particular kind. These are aspirational and ideal ambient environment conditions which are content specific.

At block 414, control signals are generated based on pre-defined ambient environment parameters (of block 412).

At block 416, the control signals are communicated (wired or wirelessly) to controllers of ambient environment lighting units and audio units for implementation. In an example, an ambient interface output module of the control system passes the relevant ambient light and audio related information to the communication module. The communication module in turn outputs this information in the form of signals and/or data (through wired or wireless means) to ambient artificial lightning units and audio units. The mapped ambient environment parameters are then implemented by the ambient environment lighting units and audio units.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A computer-implemented method of controlling an ambient environment based on content of a media, comprising:
analyzing content of a media to identify a prevalent human emotion;
recognizing a pre-defined ambient environment parameter corresponding to the identified human emotion;
generating control signals based on the pre-defined ambient environment parameter; and
sending the control signals to an ambient environment unit for creating an ambient environment corresponding to the pre-defined ambient environment parameter.

2. A method according to claim 1, wherein analyzing the media to identify a prevalent human emotion includes analyzing semantics of the media.

3. A method according to claim 1, wherein analyzing the media to identify a prevalent human emotion includes analyzing sentics of the media.

4. A method according to claim 1, wherein the media is a media currently playing on the media device.

5. A method according to claim 1, wherein recognizing a pre-defined ambient environment parameter corresponding to the identified human emotion includes referring to a mapping between an ambient environment parameter and a human emotion.

6. A method according to claim 5, wherein the mapping is pre-defined or user defined.

7. A method according to claim 1, wherein the ambient environment unit includes a lighting unit and/or an audio unit.

8. A method according to claim 1, wherein analyzing content of a media to identify a prevalent human emotion includes identifying the prevalent human emotion in a segment of the media.

9. A method according to claim 1, wherein the media includes an audio, a video or a multimedia.

10. A system for controlling an ambient environment based on content of a media, comprising:
a memory storing machine readable instructions to:
analyze content of the media to identify a human emotion;
recognize a pre-defined ambient environment parameter corresponding to the identified human emotion;
generate control signals based on the pre-defined ambient environment parameter; and
send the control signals to an ambient environment unit for creating an ambient environment corresponding to the pre-defined ambient environment parameter; and
a processor to implement the machine readable instructions.

11. A system of claim 10, further comprising a media receiving unit to receive a media.

12. A system of claim 10, wherein analyzing the media to identify a prevalent human emotion includes analyzing semantics and/or sentics of the media.

13. A system of claim 10, wherein recognizing a pre-defined ambient environment parameter corresponding to the identified human emotion includes referring to a repository containing a mapping between an ambient environment parameter and a human emotion.

14. A system of claim 10, wherein analyzing content of a media to identify a prevalent human emotion includes identifying the prevalent human emotion in a segment of the media.

15. A computer program product for controlling an ambient environment based on content of a media, comprising:
a computer readable storage medium having computer usable program code embodied therewith, the computer usable program code comprising:
computer usable program code that analyzes content of a media to identify a human emotion;
computer usable program code that recognizes a pre-defined ambient environment parameter corresponding to the identified human emotion;
computer usable program code that generates control signals based on the pre-defined ambient environment parameter; and
computer usable program code that sends the control signals to an ambient environment unit for creating an ambient environment corresponding to the pre-defined ambient environment parameter.
